(19) United States
(12) Patent Application Publication
(10) Pub. No.: US 2006/0285499 A1
(43) Pub. Date: Dec. 21, 2006

(54) Loop detection for a network device

(75) Inventor: Shrjie Tzeng, Cupertino, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 11/452,284

(22) Filed: Jun. 14, 2006

Related U.S. Application Data
(60) Provisional application No. 60/691,245, filed on Jun. 17, 2005.
(60) Provisional application No. 60/716,936, filed on Sep. 15, 2005.

(51) Int. Cl. H04J 3/14; H04L 12/56

(52) U.S. Cl. 370/249; 370/389

(57) ABSTRACT

A loop detection apparatus and method for a dumb switch having a loop detection module is configured to broadcast loop detection frames to ports of the dumb switch to detect a particular port receiving a loop detection frame indicative of a loop condition occurrence at the port. An indicator is operatively connected to the port and configured to indicate the occurrence of the loop condition allowing a user to identify the port having the loop condition.

### REFERENCE TO RELATED APPLICATIONS

This application claims priority of U.S. Provisional Patent Application Ser. Nos. 60/691,245, filed Jun. 17, 2005, and 60/716,936, filed Sep. 15, 2005. The subject matter of these earlier filed applications is hereby incorporated by reference.

### BACKGROUND OF THE INVENTION

1. Field of the Invention

The present invention relates to a loop detection apparatus and method to notify of a loop condition in a switch excluding a CPU; and more particularly to a loop detection apparatus and method facilitating a notification of an existence of a loop condition for dumb or web smart switches.

2. Description of the Related Art

One of the major features in Layer 2 (L2) managed switches is a spanning tree protocol (STP), which is a link management protocol that provides path redundancy while preventing undesirable loops in the network.

Furthermore, for an Ethernet network to function properly, for instance, only one active path can exist between two stations. Multiple active paths between stations cause loops in the network. If a loop exists in the network topology, the potential exists for duplication of messages. When loops occur, some switches see stations that appear on both sides of the switch. This condition confuses the forwarding algorithm and allows duplicate frames to be forwarded.

Spanning-Tree Protocol defines a tree that spans all switches in an extended network. A known problem relating to the use of bridge technology is the need to avoid what are referred to as “broadcast storms.” Broadcast storms may occur when bridges are connected in a physical loop, which results in a logical loop sometimes referred to as a “bridge loop.” A bridge loop occurs when data units can travel from a first LAN segment to a second LAN segment through more than one path. In order to eliminate bridge loops, existing bridge devices typically employ a technique referred to as the spanning tree algorithm. The spanning tree algorithm is implemented by bridges interchanging special messages known as Bridge Protocol Data Units (“BPDUs”). The specific format of BPDUs is described in IEEE 802.1. The spanning tree algorithm calls for various specific types of BPDUs to be sent by bridges to a special multicast address that is received by all bridges.

Using the bridge elected as a root bridge for reference, the spanning tree algorithm operates to switch one of any two bridges forming a physical loop in the network into a standby mode, so that only one side of a potential bridge loop passes traffic. By listening to configuration update BPDUs, a bridge in the standby mode can switch automatically from standby mode into forwarding mode in the event that the other bridge forming the physical loop fails. The spanning tree protocol thus ensures that physical loops in the network topology do not result in logical looping of network traffic.

While the spanning tree algorithm has proven generally effective in eliminating bridge loops, implementing the spanning tree algorithm on relatively low cost bridging devices may be prohibitively costly. A reason that prevents dumb/smart switch to implement spanning tree protocol is because of the software requirement on spanning tree protocol (STP). To run STP, a person would need at least a processor with external memory. The cost of the processor and external memory is too high for dumb/web smart switch.

For low cost bridging devices, such as dumb switches, however, a user must check manually to determine whether or not there is a loop or not, by performing a trial and error process for each port or connection. Accordingly, finding a loop in the Ethernet can be very difficult. A user needs to trace all CAT5 in the existing network. Typically, the user tries to check each Ethernet cable, which is a time consuming task and complicated when the Ethernet network become bigger.

### BRIEF DESCRIPTION OF THE DRAWINGS

Further embodiments, details, advantages and modifications of the present invention will become apparent from the following detailed description of the preferred embodiments which is to be taken in conjunction with the accompanying drawings, in which:

FIGS. 1A and 1B illustrate a chip including a loop detection module, in accordance with an embodiment of the present invention;

FIG. 1C illustrates a module level diagram of the loop detection module, in accordance with an embodiment of the present invention;

FIG. 2 illustrates a format of a loop detection frame, in accordance with an embodiment of the present invention;

FIG. 3 illustrates a method performed per chip to detect and mark loop detection frames using a module ID, in accordance with an embodiment of the present invention; and

FIG. 4 illustrates a method performed for each loop detection enabled port to detect a loop detection condition, in accordance with an embodiment of the present invention.

### DETAILED DESCRIPTION OF THE PREFERRED EMBODIMENTS

According to an embodiment of the present invention, there is provided a loop detection module and method thereof for low cost building devices such as dumb switches and/or web smart switches, including an Ethernet networking remote-office/branch-office (ROBO) switch, to assist users to easily determine which ports in the switch are in a loop condition. A dumb switch is a switch without any kind of CPU. It is the most cost effective solution with just basic switching capability. A websmart switch is a switch with an inexpensive CPU that does not have enough power to run a spanning tree algorithm. Once the loop detection feature is turned-on for a port and a loop condition is detected at the port, a light emitting diode (LED) corresponding to the particular port would blink in an alert mode and/or an alarm may be provided to generate an audio signal. By referring to the LED indication, the user can identify and fix the loop much easier. The loop detection module and method of the present invention makes it possible for the user to identify the loop faster and more efficiently than conventional procedures for loop detection in dumb switches. The loop detection feature of the present invention may run using a single chip alone. There is no need to have any CPU/microP.

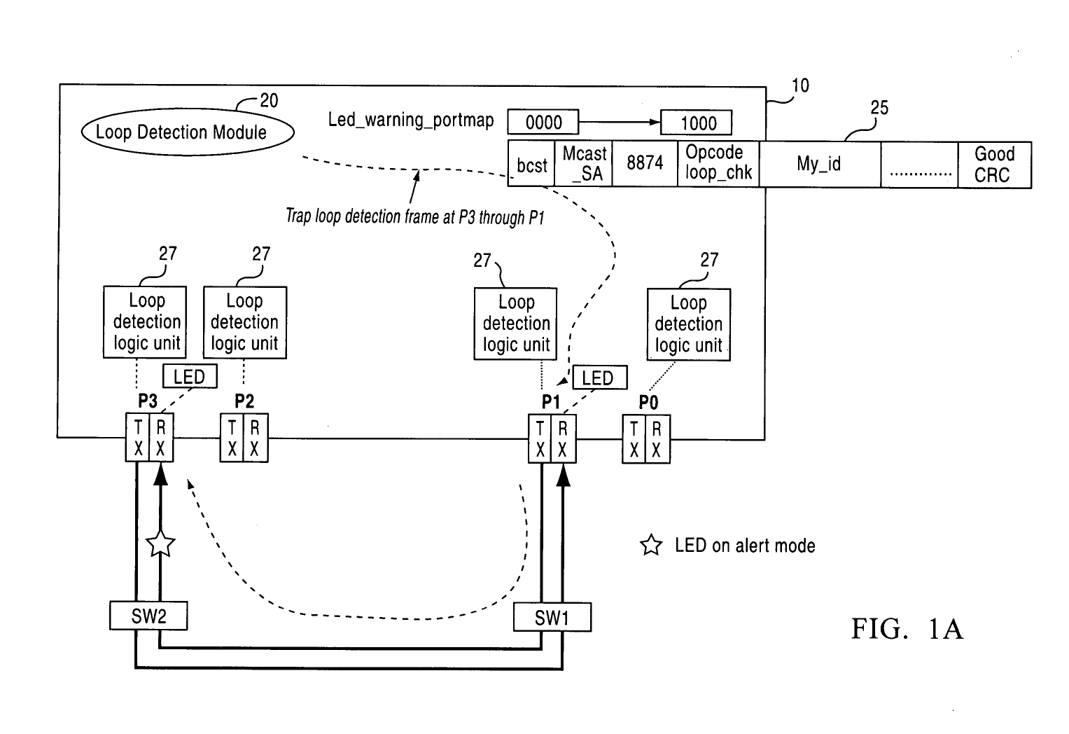

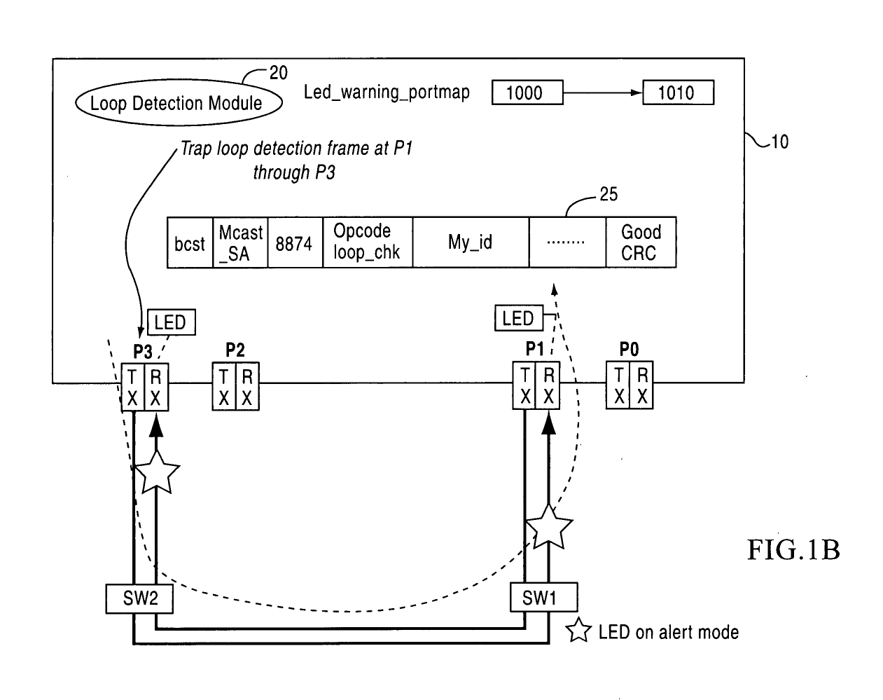

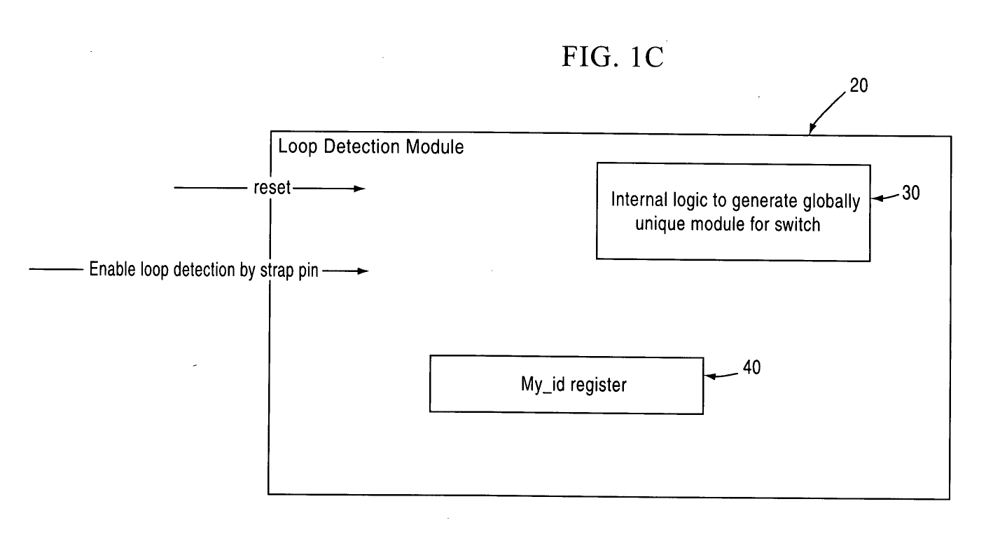

FIGS. 1A and 1B illustrate a chip 10 including a loop detection module 20, in accordance with an embodiment of the present invention. The chip 10 may be a ROBO switch, which provides an affordable Ethernet switch by incorporating high-level enterprise networking features such as network security and Quality of Service (QoS) for Voice over IP (VoIP) and multimedia applications. The chip 10 also includes communication ports P0, P1, P2, P3, . . . , etc. Although for illustrative purposes, loop detection will be applied to determine the occurrence of a loop condition within the chip 10, a person of ordinary skill in the art will appreciate that multiple chips may be provided, each including the loop detection module 20 as shown in FIGS. 1A and 1B.

A loop detection logic unit 27 is operatively connected to each port to execute loop detection logic for each port to determine whether a loop condition exists at the associated port by comparing a module ID, to be later described, of a loop detection frame 25 received at the port with a registered module ID. If the loop detection logic unit 27 determines that the module IDs match and that the loop detection frame 25 is received at the port, the loop detection logic unit 27 would determine that a loop condition exists at the port. The loop detection unit 27 would trigger the LED corresponding to the port experiencing the loop condition, thereby notifying a user that the loop condition exists at that port.

The loop condition in a chip 10 is defined as a congestion condition in which a port is receiving a loop detection frame 25 generated by the loop detection module 20 in the chip 10. The loop condition in the chip 10 is detected only when the loop detection logic associated with one of the ports of the chip 10 receives the loop detection frame 25 and determines that the loop detection frame 25 is from the same chip 10. It is determined to be a normal operation when a loop detection frame is received from other chips.

FIG. 1C illustrates a module level diagram of the loop detection module 20, in accordance with an embodiment of the present invention. At a beginning, the loop detection module 20 may receive a reset signal from a network system during initialization. An internal logic is provided to generate a unique module ID for the switch. And if the loop detection feature is enabled by the strap pin, the internal logic will kick off module ID generation process and a unique module ID will be register in the My_id register 40.

In operation, as illustrated in FIG. 1A, the loop detection module 20 broadcasts loop detection frames periodically to all ports of the chip 10, in a programmable period of time. The programmable period of time to broadcast the loop detection frames 25 may be every 1 second up to 15 seconds. As shown in FIG. 1A, a first loop detection frame broadcasted by the loop detection module 20 is transmitted through port P1 and a first and second switch, SW1 and SW2, and received at port P3 in the chip 10.

When port P3 receives the first loop detection frame from the port P1, the loop detection logic unit 27 associated with port P3 determines that a loop condition exists at port P3 and triggers an LED operatively connected to the port to flash, thereby notifying a user of a loop condition at the second port. In an alternative embodiment of the present invention, an alarm may be also implemented with the LED to generate an audio signal notifying the user of the loop detection. In the alternative, the LED and the alarm may be combined as a single unit. The alarm could be operatively connected to a dial-up. Although one LED is illustrated, multiple LED may be provided to notify the user of, for instance, full duplex/half duplex, activity, and/or speed. An LED_warning_portmap bit may be defined in the chip, in hardware, as a read-only bit to notify of the occurrence of a loop condition at a particular port.

In accordance with an alternative embodiment of the present invention, another port may be involved in the loop condition. For instance, as shown in FIG. 1B, the loop detection module 20 may generate and broadcast a second loop detection frame from port P3. In addition, the loop detection module 20 may generate and broadcast the second loop detection frame periodically. FIG. 1B illustrates detection of the second loop detection frame by a loop detection logic unit 27 associated with port P1, in accordance with an embodiment of the present invention. FIG. 1B illustrates that, when the second loop detection frame transmitted from port P3 through SW2 and SW1, the loop detection logic unit 27 of port P1 detects the second loop detection frame, thereby completing the loop between port P3 and port P1. An LED and/or an alarm operatively connected to port P1 would notify the user of a loop condition associated with port P1.

Accordingly, using the loop detection logic unit 27 of ports P1 and P3 illustrated in FIGS. 1A and 1B, the user can easily determine that port P3 and port P1 are in a loop condition. Although FIGS. 1A and 1B illustrate a direct loop between both ports to represent a loop condition, a person of ordinary skill in the art will appreciate that the loop may be form by a connection to multiple ports and multiple switches or it can be a direct CAT5 connection.

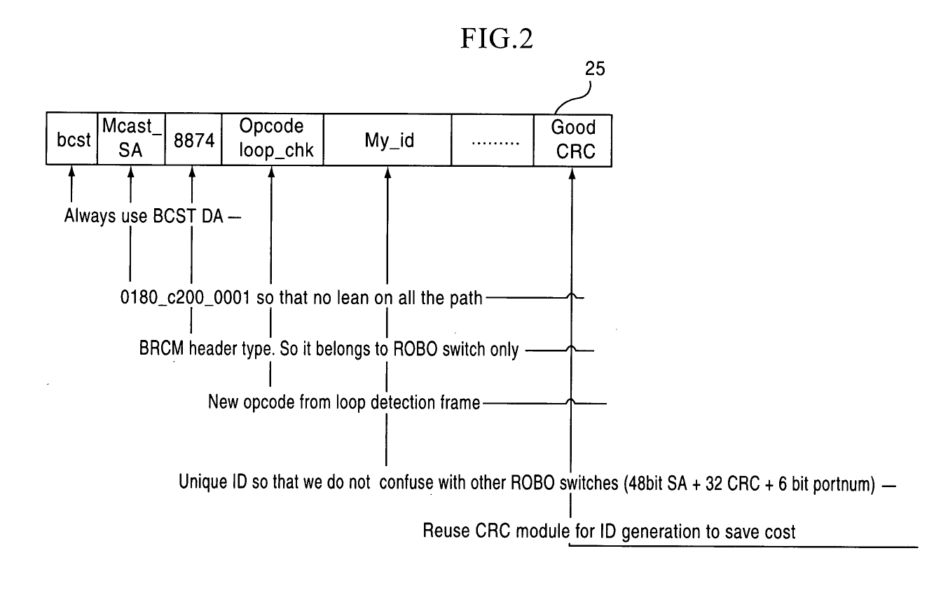

FIG. 2 illustrates a format of each loop detection frame, in accordance with an embodiment of the present invention. Each loop detection frame includes a broadcast bit (BCST) as a destination address (DA) so that the loop detection frame is transmitted to all ports of the chip 10 or to all ports of all chips. In addition, each loop detection frame includes a multicast address (Mcast_SA) bit as a source address (SA). In one instance, the Mcast_SA bit may be set to be 0180_c200_{—}0001 as the SA. Although using a multicast address as a source address may be at odds with IEEE standards, because the loop detection frame has 8874 as the Ethertype, it is intended for ROBO switches only and not intended for other types of end stations or destination stations, it would be acceptable for its intended purpose. In one embodiment of the present invention, the loop detection module 20 of the chip 10 receiving the first or the second loop detection frame would not learn the Mcast_SA of the loop detection frame to prevent accidentally changing the forwarding port decision.

In accordance with an embodiment of the present invention, a specialized header may be provided either in the header or the body of the loop detection frame to have a specific opcode. For instance, each loop detection frame may include a BRCM header, such as 8874, with opcode equal to a loop detection frame so that the loop detection frame is not treated as a valid frame or a data frame to be processed for other purposes other than for loop detection. The BRCM header is a header programmed by Broadcom Corporation, Irvine, Calif., with a loop detection opcode.

Accordingly, the loop detection logic unit 27 of each port reads the module ID from a loop detection frame to determine whether the frame is a loop detection frame from the same chip 10 or a loop detection frame from other chips. As previously indicated, it is determined to be a normal operation when a loop detection frame is received from other chips. In accordance with an embodiment of the present invention, before ports and the loop detection logic unit 27 associated with each port are set to detect a loop condition and the loop detection module 20 begins broadcasting the loop detection frames to the ports to detect a loop condition in the chip 10, the loop detection frames must be set-up to include a module ID, MY_ID, identifier which is used to label all of the loop detection frames to be broadcast by the loop detection module 20.

The module ID is the same for all the loop detection frames of the same chip 10 so that the loop detection logic unit 27 associated with each port can differentiate whether it is the loop detection frame of the chip 10 or from another chip. The module ID needs to be long enough to reduce the chance to have the same module ID for different chips or different ROBO switches. For instance, the module ID may be of any number of bits wide, such as 86 bits wide.

The loop detection apparatus and method of the present invention need to guarantee that the loop detection frame 25 is handled at a high priority. If the loop detection frame 25 is treated as a normal broadcast frame, the loop detection frame 25 may be dropped and erroneously determine that the loop condition does not exist. Accordingly, the requirement on the loop detection frame 25 handle of the loop detection module 20 is that when trapping the loop detection frame 25, it needs to be trapped even when TXQ is above TXDROP thresholds. The loop detection frame 25 may be stopped from being trapped when there is an internal resource issue in the chip 10. Another requirement of handling the loop detection module 20 is that when a port receives the loop detection frame 25, the port should treat the loop detection frame 25 as high priority.

By default, a dumb switch or a ROBO switch includes one queue. However, because the loop detection frame 25 must be treated at the high priority, the dumb switch is split into two virtual queues using internal logic, one virtual queue to handle the high priority loop detection frame 25 and the other virtual queue to process other packets. The queue is split into two using programmed logic in the logic detection module.

In order to treat the loop detection frame 25 as a high priority frame and to guarantee that another loop condition does not occur between the ports P3 and P1, an LED reset timer in the loop detection logic unit 27 is provided in the loop detector module for each port to count a preset time period that would guarantee that the loop condition has been resolved. Alternatively, the LED reset timer may be operatively connected to each port. If a loop detection frame 25 is not received between the ports P3 and P1 during the programmable time period, the loop detection module 20 determines that the loop condition has been resolved and the loop detection module 20 may be reset.

At a point of time when the loop condition is detected, the LED reset timer begins counting. The user then would resolve the loop condition. The LED reset timer would still continue to count until the preset period of time expires and it is determined that no more loop detection frame 25 is received and that, accordingly, the loop condition has been resolved. The preset period of time of the LED reset timer allows a period of time or a number of times a loop detection frame 25 may be missed or may not be detected prior to resetting the LED/alarm and the loop detection module 20.

Below is an example on how long the reset timer should wait, if the programmable period of time to be transmitting the loop detection frame 25 is set to 1 second, then the LED reset timer may set as follows:
00000: reserved
00001: wait for 1 second
00010: wait for 2× first loop detection frame timer
00011: wait for 3× first loop detection frame timer
11111: wait for 31× first loop detection frame timer
Default: 00100

In accordance with an embodiment of the present invention, the LED reset timer may be maintained at least 8 times greater than the programmable period of time to output the loop detection frame 25.

The loop detection is based on correctly received loop detection frame 25 in a timely manner. So, it is very important to trap out the loop detection frame 25 in all conditions in a timely manner. In accordance with an embodiment of the present invention, the loop detection frame 25 may be trapped in a similar way as trapping a pause frame and not follow a transmit queue (TXQ) order. Accordingly, the loop detection frame 25 may not be included in the TXQ and trap the loop detection frame 25 out even when the port is at pause on state.

In order to make sure the loop detection frame 25 can be relayed in a timely manner. The present invention provides an option of transmitting the loop detection frame 25 even when the corresponding port is at a pause-on state. The option may be applied to a highest queue traffic only. In a dumb switch, the default is just one queue. The loop detection frame 25 may be place in a Q2 and enable high queue preempt mode when the loop detection logic unit 27 is enabled. In a web smart mode, it will be up to the user to program the correct value in a register to make sure loop detection works as well.

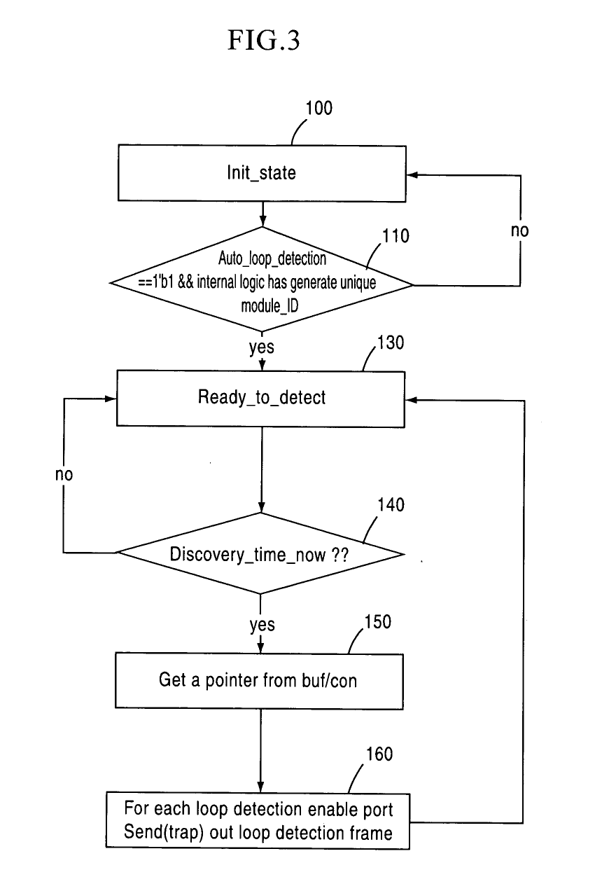

FIG. 3 illustrates a method performed per chip to detect and trap the loop detection frames using the module ID, in accordance with an embodiment of the present invention. At operation 100, the method powers-up and initializes the chip. At operation 110, the method enables some or all ports to be in a loop detection mode. Prior to trapping a loop detection frame, the module ID must be defined for the loop detection frames to be generated in the chip. At operation 130, the module ID to be used to label subsequent loop detection frames and is set ready to detect a loop condition. At operation 140, the method determines whether the time to begin the periodic broadcast transmission of the loop detection frames has arrived based on the programmable period of time set. If the method determines that the time to broadcast the loop detection frames has arrived, at operation 150, the method gets a pointer from a buffer/control to set the loop detection frames at the high priority, thereby creating two virtual queues, where one queue outputs the loop detection frames at the high priority. At operation 160, the method broadcasts the loop detection frames to the ports in the loop detection mode.

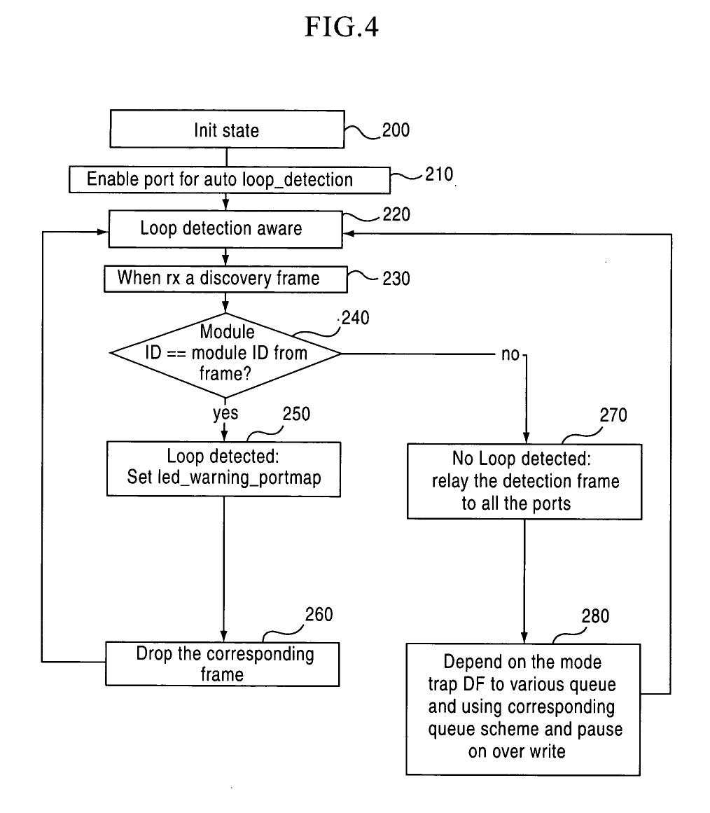

FIG. 4 illustrates a method performing a loop detection logic for each loop detection enabled port, in accordance with an embodiment of the present invention. For purposes of clarity, the method of FIG. 4 will be described as detecting a loop condition between ports P1 and P3 as illustrated in FIGS. 1A and 1B. Also, the method of FIG. 4 is performed after the module ID for all the loop detection frames has been defined and registered as described in FIG. 3. At operation 200, the method initializes the chip. At operation 210, the method sets some or all ports to be in the loop detection mode. At operation 220, the method begins broadcasting the loop detection frames to the ports in the loop detection mode.

Once a loop detection frame is detected, at operation 230, the method transmits the loop detection frame through port P1 and port P3 receives the loop detection frame. When the loop detection frame is received at port P3, at operation 240, the method extracts and compares the module ID from the loop detection frame to determine whether the loop detection frame received at port P3 is a loop detection frame from the same chip or a loop detection frame from another chip. If both module IDs match, at operation 250, the method determines a loop condition at port P3 and sets the LED/alarm to be enabled. At operation 260, the method proceeds to drop the loop detection frame so as to prevent flooding port P3 even more once the loop condition has been detected. The method returns to operation 220.

In an event that two ports are forming a loop condition, once a loop detection frame is detected, at operation 230, the method transmits the loop detection frame from port P3 to port P1. When the loop detection frame arrives at port P1, at operation 240, the method extracts and compares the module ID from the loop detection frame to determine whether the loop detection frame received at port P1 is a loop detection frame from the same chip or a loop detection frame from another chip. If both module IDs match, at operation 250, the method determines a loop condition at port P1 and sets the LED/alarm to be enabled. At operation 260, the method proceeds to drop the loop detection frame so as to prevent flooding port P1 even more once the loop condition has been detected. Accordingly, the loop is complete. The user or operator is notified of the loop condition occurring between ports P1 and P3. Accordingly, without further time consumption, use of additional resources, or troubleshooting, the user is able to detect the ports experiencing congestion. The method returns to operation 220.

However, if both module IDs do not match, at operation 270, the method determines that a loop condition has not been detected and relays the loop detection frame to all the ports. At operation 280, depending on the trap mode of the loop detection frame to various ports and using corresponding queue scheme, the method pauses on over write. The method returns to operation 220.

It is to be understood that in the embodiment of the present invention, the operations of FIGS. 3 and 4 may be performed in the sequence and manner as shown although the order of some operations and the like may be changed without departing from the spirit and scope of the present invention.

In addition, the invention has import to many types of network data. For purposes of this invention, the term frame includes packet, cell, datagram, bridge protocol data unit packet, packet data and any equivalents thereof. In addition, the method and apparatus described in the present invention may be applied to a router, fabric, a switch, and any equivalents thereof.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed:

1. A loop detection apparatus for a dumb switch, comprising:
a loop detection module configured to broadcast loop detection frames to ports of the dumb switch to detect a port receiving a loop detection frame indicative of a loop condition occurrence at the port; and
an indicator operatively connected to the port and configured to indicate the occurrence of the loop condition allowing a user to identify the port having the loop condition.

2. The loop detection apparatus as recited in claim 1, further comprising:
loop detection logic unit operatively connected to the port to determine whether the loop condition exists at the port by comparing an identifier of the loop detection frame received with a registered identifier, wherein the detection logic unit determines that the loop condition occurs at the port when the identifiers match and the loop detection frame is received at the port.

3. The loop detection apparatus as recited in claim 2, wherein the loop detection logic unit triggers a diode corresponding to the port experiencing the loop condition to notify the user that the loop condition occurs at that port.

4. The loop detection apparatus as recited in claim 2, wherein each loop detection frame comprises a broadcast bit (BCST) as a destination address (DA) so that the loop detection frame is transmitted to all ports, a multicast address (Mcast_SA) bit as a source address, a proprietary header, and the identifier.

5. The loop detection apparatus as recited in claim 1, further comprising:
an alarm operatively connected to each port of the dumb switch triggered to generate an audio signal upon the occurrence of the loop condition allowing the user to identify the port having the loop condition, wherein the indicator comprises a light emitting diode (LED).

6. The loop detection apparatus as recited in claim 1, further comprising:
a loop detection logic unit associated with the port and configured to detect the port receiving a broadcasted loop detection frame, to extract the module identifier from the broadcasted loop detection frame, to compare the module identifier and the registered module identifier, and, when the module identifier of the broadcasted loop detection frame matches the registered module identifier, to detect the port receiving the broadcasted loop detection frame indicative of a loop condition occurrence at the port; and
a light emitting diode (LED) operatively connected to the port configured to flash upon the occurrence of the loop condition allowing a user to identify the port having the loop condition.

7. The loop detection apparatus as recited in claim 1, wherein the loop detection module is further configured to set a programmable period of time to broadcast the loop detection frames, to create two virtual queues, and to provide a pointer to output the loop detection frames at a high priority using one of the queues.

8. The loop detection apparatus as recited in claim 3, wherein the port is configured to receive the broadcasted loop detection frame at a high priority.

9. The loop detection apparatus as recited in claim 3, further comprising:
an LED reset timer in the loop detection logic unit in the loop detector module for each port to count a preset time period to guarantee that the loop condition has been resolved.

10. A loop detection apparatus for a dumb switch, comprising:
loop detection means for broadcasting loop detection frames to ports of the dumb switch to detect a particular port receiving a loop detection frame indicative of a loop condition occurrence at the port; and
light emitting means operatively connected to the port and triggered to indicate the occurrence of the loop condition allowing a user to identify the port having the loop condition.

11. The loop detection apparatus as recited in claim 10, further comprising:
loop detection logic means operatively connected to the port for determining whether the loop condition exists at the port by comparing an identifier of the loop detection frame received with a registered identifier, wherein the detection logic means determines that the loop condition occurs at the port when the identifiers match and the loop detection frame is received at the port.

12. The loop detection apparatus as recited in claim 11, wherein the loop detection logic means triggers a diode corresponding to the port experiencing the loop condition to notify the user that the loop condition occurs at that port.

13. The loop detection apparatus as recited in claim 11, wherein each loop detection frame comprises a broadcast bit (BCST) as a destination address (DA) so that the loop detection frame is transmitted to all ports, a multicast address (Mcast_SA) bit as a source address, a proprietary header, and the identifier.

14. The loop detection apparatus as recited in claim 10, further comprising:
alarm means operatively connected to each port of the dumb switch triggered for generating an audio signal upon the occurrence of the loop condition allowing the user to identify the port having the loop condition, wherein the indicator comprises a light emitting diode (LED).

15. The loop detection apparatus as recited in claim 10, further comprising:
loop detection logic means associated with the port and configured for detecting the port receiving a broadcasted loop detection frame, for extracting the module identifier from the broadcasted loop detection frame, for comparing the module identifier and the registered module identifier, and, when the module identifier of the broadcasted loop detection frame matches the registered module identifier, for detecting the port receiving the broadcasted loop detection frame indicative of a loop condition occurrence at the port; and
light emitting diode (LED) means operatively connected to the port for flashing upon the occurrence of the loop condition allowing a user for identifying the port having the loop condition.

16. The loop detection apparatus as recited in claim 10, wherein the loop detection means further sets a programmable period of time for broadcasting the loop detection frames, for creating two virtual queues, and for providing a pointer to output the loop detection frames at a high priority using one of the queues.

17. A loop detection method for a dumb switch, comprising:
broadcasting loop detection frames to ports of the dumb switch;
detecting a particular port receiving a loop detection frame indicative of a loop condition occurrence at the port; and
triggering an indicator operatively connected to the port to indicate the occurrence of the loop condition allowing a user to identify the port having the loop condition.

18. The loop detection method as recited in claim 17, further comprising:
comparing an identifier of the loop detection frame received with a registered identifier;
determining that the loop condition occurs when the identifiers match and the loop detection frame is received at the port;
determining that the loop condition occurs at the port and triggers a diode corresponding to the port experiencing the loop condition to notify the user that the loop condition occurs at that port.

19. The loop detection method as recited in claim 17, further comprising:
generating an audio signal upon the occurrence of the loop condition.

20. The loop detection method as recited in claim 17, further comprising:
detecting a port receiving a broadcasted loop detection frame;
extracting the module identifier from the broadcasted loop detection frame;
comparing the module identifier and the registered module identifier;
receiving the broadcasted loop detection frame at the port indicative of a loop condition occurrence at the port when the module identifier of the broadcasted loop detection frame matches the registered module identifier; and
triggering an indicator operatively connected to the port to indicate the occurrence of the loop condition allowing a user to identify the port having the loop condition.

21. The loop detection method as recited in claim 17, further comprising:
setting a programmable period of time to broadcast the loop detection frames;
creating two virtual queues; and
providing a pointer to output the loop detection frames at a high priority using one of the queues, wherein the broadcasted loop detection frame is a high priority frame.

22. The loop detection method as recited in claim 20, wherein the marking of each broadcasted loop detection frame with the module identifier allows to differentiate whether the broadcasted loop detection frame corresponds to the dumb switch or corresponds to another dumb switch.

23. The loop detection method as recited in claim 20, wherein the receiving of the broadcasted loop detection frame is performed when TXQ is above TXDROP thresholds.
